(19) United States
(12) Patent Application Publication
(10) Pub. No.: US 2019/0050926 A1
(43) Pub. Date: Feb. 14, 2019

(54) LIVESTOCK TRADING PLATFORM

(71) Applicant: FUSION FOUNDRY, LLC, HEATH, TX (US)

(72) Inventor: ERIK B. COOPER, COLLEYVILLE, TX (US)

(21) Appl. No.: 15/892,408

(22) Filed: Feb. 8, 2018

Related U.S. Application Data
(60) Provisional application No. 62/460,048, filed on Feb. 16, 2017.

(51) Int. Cl. G06Q 30/06; G06Q 20/02; G06Q 10/08; H04W 4/021; H04W 4/35; G06K 9/00; A01K 29/00

(52) U.S. Cl. CPC G06Q 30/0623; G06Q 20/027; G06Q 10/083; A01K 29/005; H04W 4/35; G06K 9/00885; H04W 4/021

(57) ABSTRACT

The Livestock Trading Platform invention is a novel confluence of software and hardware to improve how livestock are managed and marketed. The collection of animal biometric data inclusive of facial recognition and weight estimates along with a distributed ledger payment gateway and a geo-fencing system to control animal grazing locations and movements will allow livestock producers to supply livestock consumers, individual, animal-level traceability data which, taken in aggregate, will allow a livestock producers to supply a livestock consumers with whole herd data.

### BACKGROUND

The present disclosure relates generally to systems and methods that streamline and improve livestock identification, livestock production, and logistics of selling and purchasing livestock as originally outlined in Provisional Filing Application No. 62/460,048 dated Feb. 16, 2017.

Traditionally, livestock are transported from farm to table via an orthodox auction or sale barn method. Such a method involves purchasers purchasing the livestock at an auction or sale barn. The orthodox sale barn method involves a labor intensive sales process with limited asset-level information such as livestock traceability, safety, and animal welfare concerns. Labor inefficiencies and limited information relating to the livestock result in increased livestock costs and a potential decrease in livestock quality.

### SUMMARY OF THE DISCLOSED EMBODIMENTS

The disclosed embodiments include a system for purchasing and selling livestock. In particular, the disclosed embodiments include a non-transitory computer readable medium including a set of instructions that, in operation, cause a computer processor to assign biometric data and facial recognition data to individual animals within a herd. The instructions also instruct the computer processor to receive an indication to purchase one or more of the individual animals within the herd. A distributed ledger payment gateway of a livestock trading platform is utilized by the computer processor to clear payments to purchase the one or more of the individual animals within the herd. Additionally, the instructions cause the computer processor to employ the livestock trading platform to automatically arrange transportation of the one or more of the individual animals within the herd to a purchaser. In certain embodiments, the instructions cause the computer processor to control movement and grazing locations of the herd using a geo-fencing system.

Additional details of the disclosed embodiments are provided below in the detailed description and corresponding drawings. Indeed, the disclosed embodiments contains no new matter.

### BRIEF DESCRIPTION OF THE DRAWINGS

For a more complete understanding of the description provided herein and the advantages thereof, reference is now made to the brief descriptions below, taken in connection with the accompanying drawings and detailed description, wherein like reference numerals represent like parts.

FIG. 1 is an electronic device that operates a livestock trading platform, in accordance with a disclosed embodiment;

FIG. 2 is an image captured within the livestock trading platform of FIG. 1 used to estimate biometric data of livestock, in accordance with a disclosed embodiment;

FIG. 3 is another image captured within the livestock trading platform of FIG. 1 used to provide livestock facial recognition capabilities, in accordance with a disclosed embodiment;

FIG. 4 is a schematic illustration of a fenced in portion of property with interior geo-fencing, in accordance with a disclosed embodiment; and

FIG. 5 is a flowchart depicting a process for purchasing livestock from the livestock trading platform of FIG. 1, in accordance with a disclosed embodiment.

The illustrated figures are only exemplary and are not intended to assert or imply any limitation with regard to the environment, architecture, design, or process in which different embodiments may be implemented.

### DETAILED DESCRIPTION

In the description that follows, the drawing figures are not necessarily to scale and certain features may be shown in generalized or schematic form in the interest of clarity and conciseness or for informational purposes. In addition, although making and using various embodiments are discussed in detail below, it should be appreciated that, as described herein, many inventive concepts that may be embodied in a wide variety of contexts are provided. Embodiments discussed herein are merely representative and do not limit the scope of the invention.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

Embodiments of a livestock trading platform are disclosed herein that streamline the purchase of livestock between livestock producers or from livestock producers to protein processors. In an embodiment, the livestock trading platform provides an online marketplace for trading livestock. In addition, the livestock trading platform provides a mechanism that is able to estimate the biometrics of livestock based on images captured by an electronic device, identify individual livestock with facial recognition, control geo-fencing of a piece of property on which the livestock graze, provide a payment gateway for the purchase of livestock, provide logistics automation for transport of the livestock, or any combination thereof. The streamlined nature of the livestock trading platform reduces labor and time costs associated with the sale of livestock and increase information available to a livestock purchaser about the livestock at a time of sale.

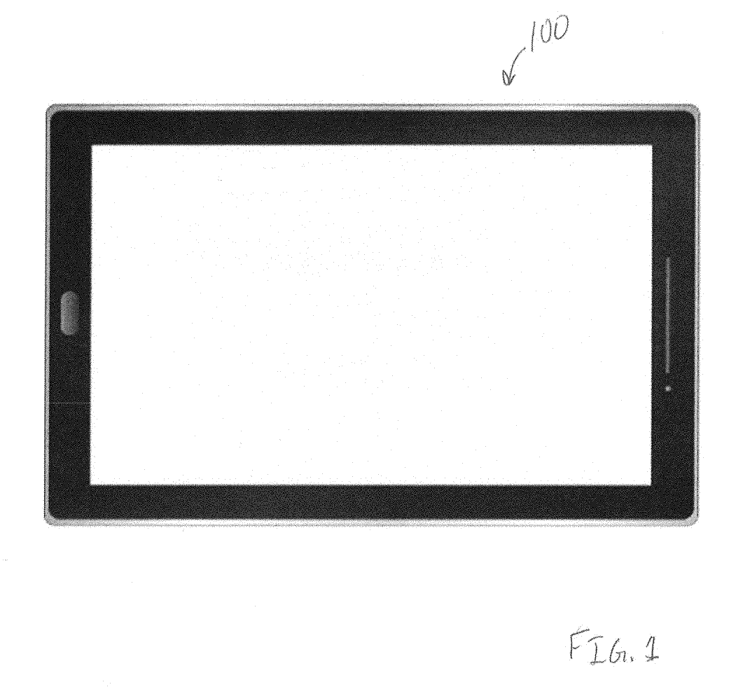

Referring now to the drawings, FIG. 1 is an electronic device 100 that operates a livestock trading platform. As discussed above, the livestock trading platform provides a user of the electronic device 100 with the ability to buy or sell livestock in an efficient manner. The electronic device 100 includes at least one memory to store instructions that, when executed by at least one processor of the electronic device 100, cause the electronic device 100 to run the livestock trading platform.

A seller of livestock may use a camera integrated in the electronic device 100 to capture images of the livestock within the herd of the seller. The images are usable by the livestock trading platform to estimate a weight of the livestock captured in the image. In this manner, the seller is able to provide a reliable estimate of a weight of the livestock the seller wishes to sell without having to rely on livestock scales.

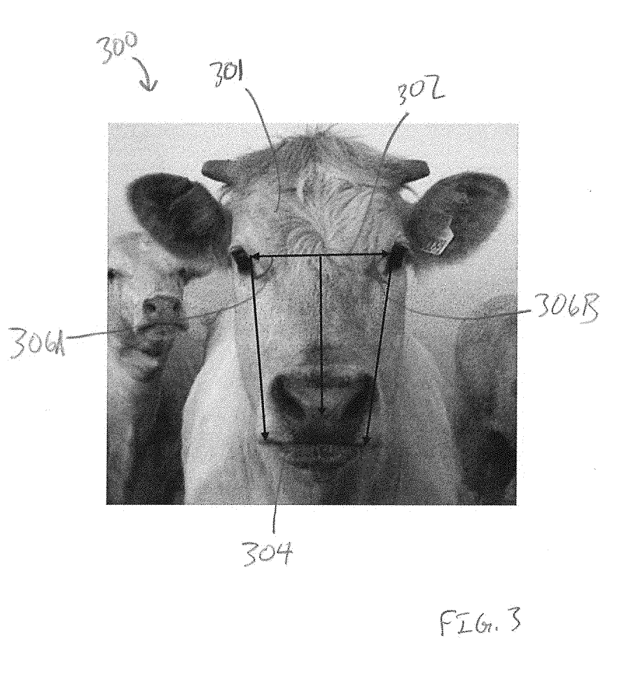

Additionally, images captured by the camera integrated in the electronic device 100 may be used by the livestock trading platform to identify an individual animal. For example, the livestock trading platform is able to use facial recognition of the livestock to track individual animals. As discussed in detail below with reference to FIG. 3, facial characteristics of various animals are able to provide reference points to establish and track the identity of an animal.

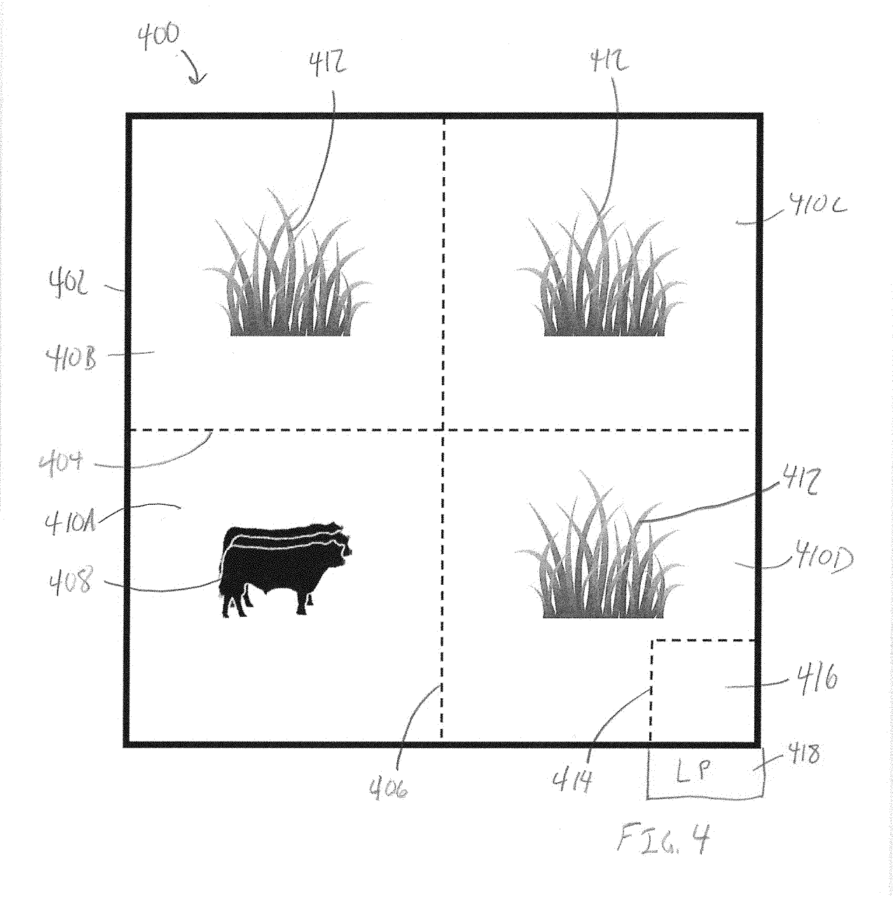

The electronic device 100 also provides the livestock sellers with an interface for controlling geo-fencing of livestock within an area of property, as discussed in detail below with reference to FIG. 4. A payment gateway and a logistics application programming interface (API) is also provided within the livestock trading platform, with which a buyer or seller is able to interact via the electronic device 100. The electronic device 100 may include smart phones, tablets, laptop computers, desktop computers, or any other electronic devices able to run the livestock trading platform and able to communicatively couple to the internet. While the camera is described as being integrated into the electronic device 100, a user is also able to capture images of livestock from a camera separate from the electronic device 100 and subsequently upload the captured images on the electronic device 100 running the livestock trading platform.

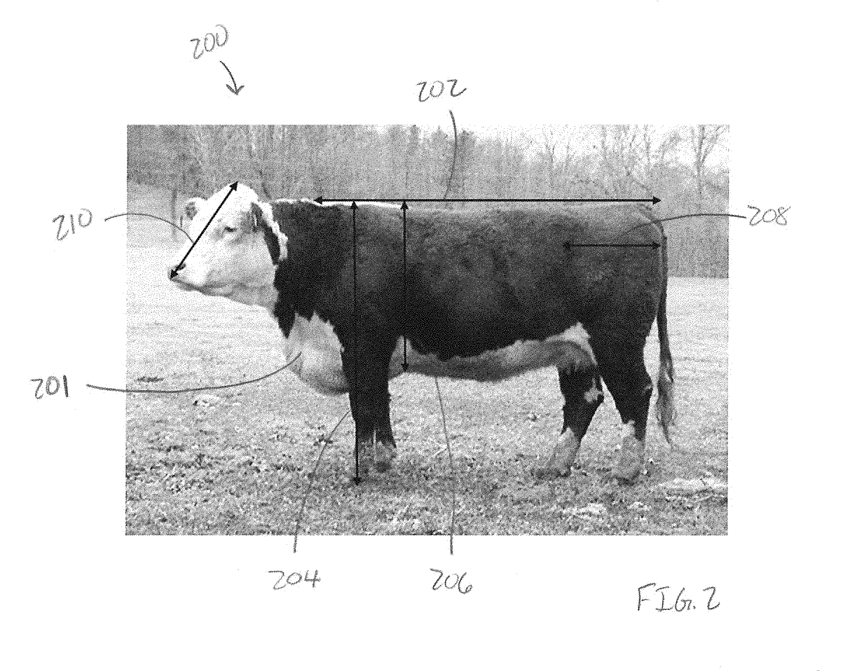

FIG. 2 is an image 200 of an individual animal 201. The image 200 is captured within the livestock trading platform that is run on the electronic device 100. The livestock trading platform analyzes the image 200 to provide biometric estimations to the buyers and sellers. For example, the livestock trading platform uses measurements obtained from the image 200 to estimate a weight of the individual animal 201. Further, a seller is able to capture images 200 of each individual animal 201 within a herd that is for sell. Capturing the images 200 of each individual animal 201 provides buyers with an estimate of the weights for each of the individual animals 201 in addition to a total weight of the herd that is for sell.

Livestock weights are relied upon in the protein industry because a value of the animal 201 is based on how much the animal 201 weighs. In place of the animal 201 physically standing on a scale on the premises of a livestock auction barn, which is a time and labor intensive process, the weight of the animal 201 is estimated based on measurements of the animal 201 taken from the image 200. In particular, the livestock trading platform may measure, for example, a body length 202 of the animal 201, a shoulder height 204 of the animal 201, a heart girth 206 of the animal 201, a rump length 208 of the animal 201, a skull length 210 of the animal 201, any other useful lengths of the animal 201, or any combination thereof. The livestock trading platform may compare the measurements obtained from the image 200 to a database corresponding to measurements of a specific breed of animal being measured (e.g., Red Angus cattle, Beefmaster cattle, Brahman cattle, etc.). A weight of the individual animal 201 is determined based on the comparison of the measurements of the individual animal 201 to the database measurements of the specific breed of the individual animal 201.

Providing a livestock producer with the ability to estimate the size of livestock inventory reduces costs associated with selling the livestock inventory by reducing reliance on third parties to provide weight measurements. Further, if an institutional buyer, such as a feedlot, purchases an animal, the animal is weighed once it disembarks a truck at the feedlot. This new weight, when taking into account journey shrinkage from the producer to the feed lot, provides the institutional buyer measurement confirmation that the weight estimated by the livestock trading platform was accurate. Alternatively, the livestock trading platform may provide the ability for the institutional buyer to adjust payment should the weight of the animal 201, as it disembarks the truck at the feedlot, be below an acceptable range attributable to journey shrinkage.

FIG. 3 is an image 300 of an individual animal 301. The image 300 is captured within the livestock trading platform of the electronic device 100, and the livestock trading platform using the image 300 to provide livestock facial recognition capabilities to a user of the livestock trading platform. A face of the individual animal 301, such as beef cattle, is unique to the individual animal 301. The livestock trading platform is able to assign an identity to the individual animal 301 based on eye distance 302, nose position 304 in relation to the eyes, and mouth angles 306A and 306B from an eye plane (e.g., along a line showing the eye distance 302). Further, any other measurements of the face of the individual animal 301 may also be taken into account to establish identifying features of the individual animal 301.

If animal facial recognition and biometrics evaluation are used on the livestock trading platform, the user of the livestock trading platform is able to create granular, asset-level data without using ear tags or RFID chips to differentiate the individual animals 301. Facial recognition allows the user to collect measurement data on the individual animals 301, associate the data with the facial recognition of individual animals 301, and see how the measurement data changes over time. Moreover, in an embodiment, data collection may be available with the facial recognition module uploaded to a drone with a defined flight path. Using the identification of the individual animals 301 from the defined flight path of the drone, the user is able to track movement of the individual animals 301 on a daily basis. Further, the user is able to track movement trends of the individual animals 301 over time, or verify movement of the individual animals 301 in response to geo-fencing, as described in detail below with reference to FIG. 4.

FIG. 4 is a schematic illustration of a fenced in portion of property 400 with interior geo-fencing. As illustrated, the fenced in portion of property 400 includes a physical perimeter fence 402. The physical perimeter fence 402 may be made from a collection of traditional fencing materials, cattle guards, gates, and any other type of fencing material capable of maintaining livestock within the physical perimeter fence 402. While the perimeter fence 402 is used by a rancher to maintain livestock on a specific area of property (e.g., within the fenced in portion of property 400), it is also beneficial for a rancher to sub-divide the fenced in portion of property 400 to enable crop rotation on the fenced in portion of property 400 while preventing access to portions of the property that are in a crop growing cycle. However, each mile of traditional fence costs between $4,000 and $5,000 to install in addition to costs associated with the upkeep of the traditional fence. Having the ability to dynamically change an interior of the fenced in portion of property 400 with an invisible geo-fence improves land stewardship and provides a mechanism for easy crop rotation of grazing grass for the livestock.

To help illustrate, the fenced in portion of property 400 may be divided by geo-fencing lines 404 and 406. The geo-fencing lines 404 and 406 may be established based on GPS coordinates and activated and controlled using geo-fencing controllers positioned on livestock 408. The geo-fencing controllers may include shock collars, vibration collars, or noise makers that are outfitted on the livestock 408. When the livestock 408 is moving in a direction contrary to a desired geo-fenced area, the geo-fencing controllers provide a stimulation to the livestock 408 that indicates to the livestock 408 that they are travelling in the wrong direction. In this manner, the livestock 408 is controlled into an area defined by the geo-fencing lines 404 and 406.

To help illustrate, within the fenced in portion of property 400, a rancher may desire that the livestock 408 graze within a quadrant 410A, the boundaries of which are defined by the geo-fencing lines 404 and 406 and the physical perimeter fence 402. While the livestock 408 grazes in the quadrant 410A, grazing grass 412 in quadrants 410B, 410C, and 410C may grow without grazing interference from the livestock 408. When the rancher determines that the livestock 408 has reached a desired grazing utilization in the quadrant 410A, the rancher changes the grazing quadrant to the quadrant 410B via a geo-fencing module of the livestock trading platform to allow the grazing grass to regrow in the quadrant 410A. When the grazing quadrant is changed, the geo-fencing controller provides a stimulation to the livestock 408 that ultimately results in movement of the livestock 408 to the quadrant 410B. This process is repeated from quadrant to quadrant until the livestock 408 is sold. Further, the geo-fencing module may aid the rancher in keeping track of the individual animals 201 and 301, as described above with reference to FIGS. 2 and 3, due to the livestock 408 being confined to a defined smaller area within the much larger fenced in portion of the property 400.

Additionally, the geo-fencing module provides easier round-up of the livestock 408 to a loading platform. For example, a geo-fence line 414 may define a staging area 416 adjacent to a loading platform 418 for the livestock 408. The rancher may use the geo-fencing module of the livestock trading platform to control the livestock 408 that has been sold on the livestock trading platform to the staging area 416 in preparation of transporting the livestock 408 to the purchaser. Additionally, the identity of each individual animal 301 may be associated with a specific geo-fencing controller. In this manner, the geo-fencing module is able to direct the individual animals 301 that have been sold on the livestock trading platform to the staging area 416 for transport to the new owners.

Further advantage of the geo-fencing module include enabling the rancher to track where the livestock 408 grazes over time. This information allows the rancher to provide accurate information about the source of nutrients that the livestock 408 has received to the purchaser. Additionally, should the rancher discover that soil or grazing grass in a specific area within the fenced in portion of the property 400 is inadequate for various reasons, the rancher is able to remove that specific area from a grazing path of the livestock 408. Control of the livestock 408 in such a manner results in greater and more complete amounts of information pertaining to the livestock 408 that is available to the purchaser.

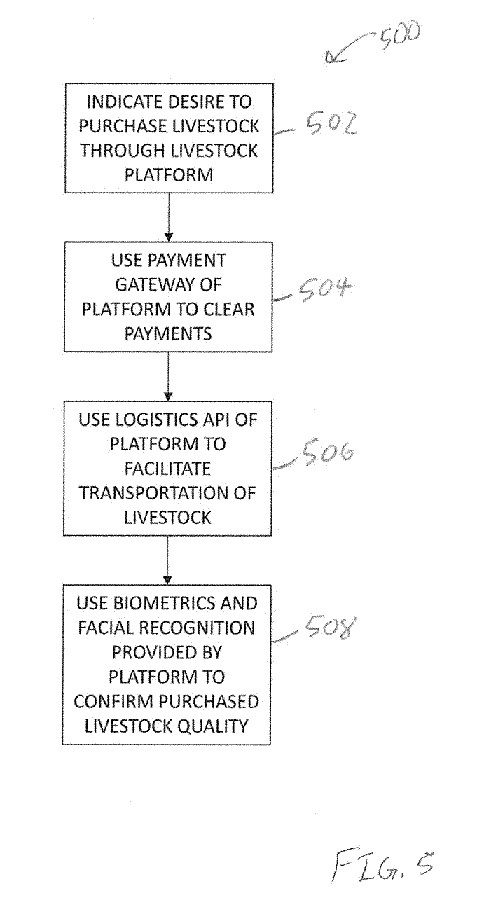

FIG. 5 is a flowchart depicting a process 500 for purchasing the livestock 408 from the livestock trading platform on the electronic device 100. At block 502, a purchaser indicates a desire to purchase the livestock 408 through the livestock trading platform. The purchaser is able to select from inventory listed within the livestock trading platform across several ranches without either the purchaser or the seller having to travel to an auction barn. The purchaser is provided a reliable estimation of the weight and measurements of the livestock 408 indicated in the inventories within the livestock trading platform.

Subsequently, at block 504, the purchaser uses a payment gateway of the livestock trading platform to clear payments. Traditionally, cash trade of livestock has been cleared using paper checks that are deposited at a bank. The payment gateway of the livestock trading platform provides the user with the convenience of using credit cards, interne based payment systems, automated clearing houses, and/or cryptocurrency to clear payments between the buyers and the sellers.

At block 506, a logistics application programming interface (API) of the livestock trading platform is used to facilitate transportation of the livestock 408 to the purchaser. For example, the logistics API may automatically identify available transporters in the vicinity of the seller and request quotes for transporting the livestock 408 from the purchaser to the seller. The logistics API may also communicate with the available transporters the estimated weight of the purchased livestock 408 to ensure that the available transporters are able to transport the purchased livestock 408. Additionally, in an embodiment, the logistics API automatically schedules the transport with an available transporter that provided the most desirable quote. Desirability of the quote may be based on cost of transport, customer satisfaction with available transporters, timeline of transport, or any other factors that are desirable in determining the quality of a specific transporter.

After transport of the livestock 408 to the purchaser, at block 508, the purchaser may use biometric and facial recognition modules of the livestock trading platform to confirm that the livestock 408 that was selected by the purchaser for purchase in the livestock trading platform is the livestock 408 that was delivered to the purchaser. Additionally, when the purchaser is an institutional buyer, the purchaser may weigh each of the individual animals 201/301 to confirm that the weight estimations of the livestock trading platform was accurate.

The above disclosed embodiments have been presented for purposes of illustration and to enable one of ordinary skill in the art to practice the disclosed embodiments, but is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/blocks may be performed in parallel or out of sequence, or combined into a single step/block. The scope of the claims is intended to broadly cover the disclosed embodiments and any such modification. Additionally, although specific terms are employed herein, they are used in a generic and descriptive sense only and not for purposes of limitation.

What is claimed is:

1. A non-transitory computer readable medium comprising a set of instructions that in operation cause a computer processor to:
assign biometric data and facial recognition data to individual animals within a herd;
receive an indication to purchase one or more of the individual animals within the herd;
use a payment gateway of a livestock trading platform to clear payments to purchase the one or more individual animals within the herd;
use the livestock trading platform to automatically arrange transportation of the one or more of the individual animals within the herd to a purchaser.

2. The computer readable medium of claim 1, comprising instructions that in operation cause the computer processor to:
control movement and grazing locations of the herd using a geo-fencing system.

3. The computer readable memory of claim 2, wherein controlling movement of the herd comprises instructing, using the geo-fencing system, the one or more of the individual animals within the herd that have been purchased to move to a staging area.

4. The computer readable memory of claim 1, wherein the facial recognition data comprises a distance between eyes of the individual animals, a position of a nose of the individual animals in relation to the eyes, an angle of a mouth of the individual animals in relation to an eye plane associated with the eyes of the individual animals, or any combination thereof.

5. The computer readable memory of claim 1, wherein the biometric data comprises:
measurements of the individual animals comprising a body length of the individual animals, a shoulder height of the individual animals, a heart girth of the individual animals, a rump length of the individual animals, a skull length of the individual animals, or any combination thereof; and
an estimated weight of the individual animals based at least in part on the measurements of the individual animals.

6. The computer readable memory of claim 5, wherein the measurements are obtained from an image of the individual animals captured by a camera.

7. A system and method as shown and described herein.
